(19) United States
(12) Patent Application Publication
(10) Pub. No.: US 2008/0315577 A1
(43) Pub. Date: Dec. 25, 2008

(54) Threadless quick connect tubular coupling disconnection tool

(75) Inventors: Sandeep Pavnaskar, Dunlap, IL (US); Eric E. Foster, Morton, IL (US); Brandon J. Croegaert, Aurora, IL (US); Manmohan Sappidi, Chennai (IN)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 11/821,126

(22) Filed: Jun. 22, 2007

(51) Int. Cl. B25G 3/08; F16L 37/00

(52) U.S. Cl. 285/86; 16/436

(57) ABSTRACT

A quick coupling disconnection tool having a head portion with two engagement projection fingers generally forming a v-shape to accept various hose coupling sizes, a handle, and a shank connecting the handle portion to the head portion.

### TECHNICAL FIELD

The present disclosure relates generally to work tools. More particularly, the present disclosure relates to disconnection tools used with threadless quick connect tubular couplings.

### BACKGROUND

Threadless quick connect tubular couplings are used in numerous industries including agricultural, construction, forestry, transportation, and utility. Quick connect applications are pervasive and are most commonly used in refrigerant supply lines and power steering lines, pneumatic brakes and air supply lines, transmission oil coolers and heat exchangers, fuel injection systems, hydraulic work circuits, and hydraulic pilot systems.

Threadless quick connect tubular couplings typically include a male portion in operable engagement with a female portion. Threadless quick connect tubular couplings are particularly desirable in locations that are not readily accessible since these couplings often eliminate the need for engaging a threaded connection and the associated danger of cross threading.

A quick disassembly or disconnect is also important when removing components for maintenance, replacement, and/or repair. A quick disconnection of the joint during production for repair or reconfiguration will save time and money. Enabling a quick disconnection also has significant advantages from a serviceability standpoint, when the equipment is out in the field or with a dealer for repair. A critical step in the disassembly of a threadless quick connect tubular coupling is the initial forward push of the steel insert on the dust boot (or release sleeve) to expand the steel latch ring and disengage the connection. A disconnect tool, inserted behind the dust boot (or release sleeve) is needed to uncouple the male and female connector. The thickness of the tool moves the sleeve forward far enough to make the disconnection, so prying sideways with the tool is unnecessary. In addition, the dimensions on ramp angle and the edges of the tool allow for reduced disconnection force and locking of the tool on the connection during disconnection. Prying on threadless quick connect tubular parts with a disconnect tool should be avoided at all times, as it can easily result in damage.

Tools are available in the industry for this purpose. For example, a Snap To Connect (STC) disassembly tool set, sold by the Eaton Hydraulics Company of Cleveland, Ohio 44114 is disclosed in the April 2004 Eaton Hydraulics STC Connectors brochure. The tools are sold in a 5-7-piece set, in order to cover the various sized coupling connection diameters. Each tool of the set has a u-shaped opening and a separate specific sized radius tool is needed for each and every individually sized STC coupling hose diameter.

Due to the individual unique sizing for each, the tool has been marked, with acute industry service and repair use problems. Generally speaking, use of the prior art tool increases the probability of damaging the coupling fittings, and increases the likelihood of operator error from using the wrong sized tool. Further, the one-size fits one nature of the tool causes increases production time when an operator has to wait for the right sized tool if the right size is not readily available. This becomes especially critical during servicing the equipment in the field where lack of the right sized tool may create longer repair times and result in customer dissatisfaction. Most notably, there are increased distribution and material costs due to the numerous sizes of the tool that must be purchased to cover the range of connector sizes used by the industry.

These and other difficulties experienced with the prior art tools have been obviated in a novel manner by the present disclosure.

### SUMMARY OF THE INVENTION

The presently disclosed embodiment can be characterized as a quick coupling disconnection tool having a head portion with two engagement projection fingers generally forming a v-shape to accept various hose coupling sizes, a handle, and a shank connecting the handle portion to the head portion.

Alternatively, the presently disclosed embodiment can be characterized as a quick coupling disconnection tool having at least two head portions, the inner walls of one of the at least two head portions having two engagement projection fingers generally forming a smooth v-shape to accept various hose coupling sizes, and the inner walls of the other of the at least two head portions having two engagement projection fingers generally forming a stepped v-shape to accept various hose coupling sizes.

### BRIEF DESCRIPTION OF THE DRAWINGS

FIG. 1 is a diagrammatic top view illustration of a threadless quick connect tubular coupling disconnection tool according to an exemplary embodiment of the present disclosure.

FIG. 2 is a diagrammatic isometric side view illustration of the threadless quick connect tubular coupling disconnection tool of the present disclosure.

FIG. 3 is a prospective view of an embodiment of the threadless quick connect tubular coupling disconnection tool of the present disclosure.

### DETAILED DESCRIPTION

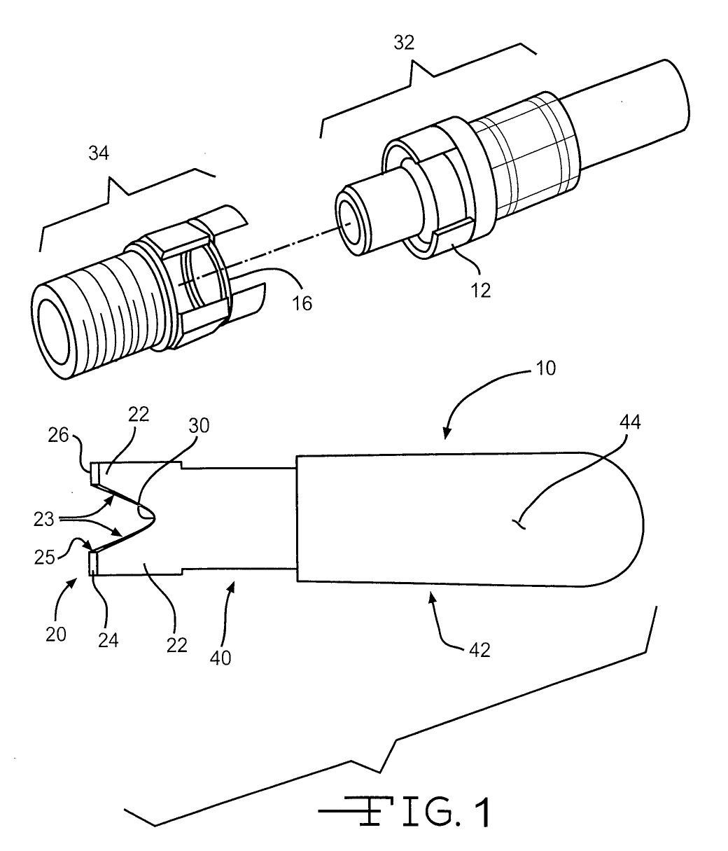

Referring first to FIG. 1, an embodiment of the threadless quick connect tubular coupling disconnection tool 10 is generally illustrated. The various components of the disconnection tool 10 include a head portion 20, a shank portion 40 and a handle portion 42. The shank portion 40 connects the head portion 20 to the handle portion 42. The head portion may be forged or formed of metal and suitably heat treated. The handle portion 42 may by covered or coated with a comfort-grip material 44.

The head portion 20 of the tool has a pair of engagement projection fingers 22. The inner walls 23 of the engagement projection fingers 22 generally form a v-like shape, namely, the opposing inner walls 23 lie at about forty-five degrees from each other. The bottom of the generally v-shaped opening of the head portion forms a curved line 30 resembling a half circle. The curved line 30 may or may not have a uniform radius, but does not intersect to create a sharp point.

The engagement projection fingers 22 have two plane face surfaces 24 and 25. The plane face surfaces 24 and 25 lie at an acute angle to one another and terminate in a transverse edge 26. The distance between the two plane face surfaces 24 and 25 provide the disconnect width needed for disengagement of the connected components of a threadless quick connect tubular coupling.

Again referring to FIG. 1, to create the threadless quick connect tubular coupling, an exemplary male shoulder 32 is inserted into an exemplary female connector 34. The male shoulder may spread a latching ring 16 open. When the latching ring 16 is in its open position, the male shoulder 32 can slide past the latching ring. The male shoulder 32 and female connector 34 are then locked into place. As fluid pressure is applied, the latching ring 16 becomes wedged between the male shoulder 32 and the female connector 34.

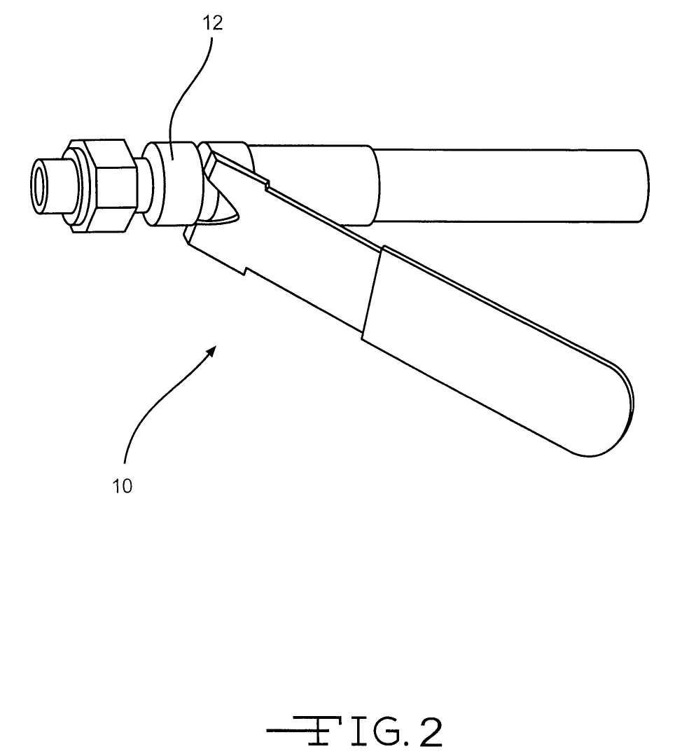

Referring now to FIG. 2, the threadless quick connect coupling disconnection tool 10 is shown inserted behind a release sleeve 12. During the disconnection action utilizing the disconnection tool 10, a steel insert may push the latching ring 16 forward into a groove (not shown) in the female half inner diameter, allowing a male shoulder 32 and a female connector 34 to be disconnected. The disconnection tool 10 may be left inserted to aid disassembly, or immediately released from the threadless quick connect tubular coupling. To help avoid release sleeve tearing, a disconnection tool insertion gap (not shown) may be created by moving the release sleeve in the release direction using a single projection of the threadless quick connect tubular coupling disconnect tool 10, prior to completely inserting the disconnection tool 10.

The overall dimensions of the tool may vary according to need; however, the overall width (thickness) of the tool 10 is appropriately sized to move the release sleeve 12 forward far enough to make the disconnection, so that prying sideways with the tool 10 is unnecessary. The overall length of the disconnection tool is appropriate to hold comfortably in the hand and reach the areas for disconnection. The dimensions and orientation angles on the handle may also vary according to need to reach inaccessible areas of the machine and make it most ergonomically friendly for the technicians.

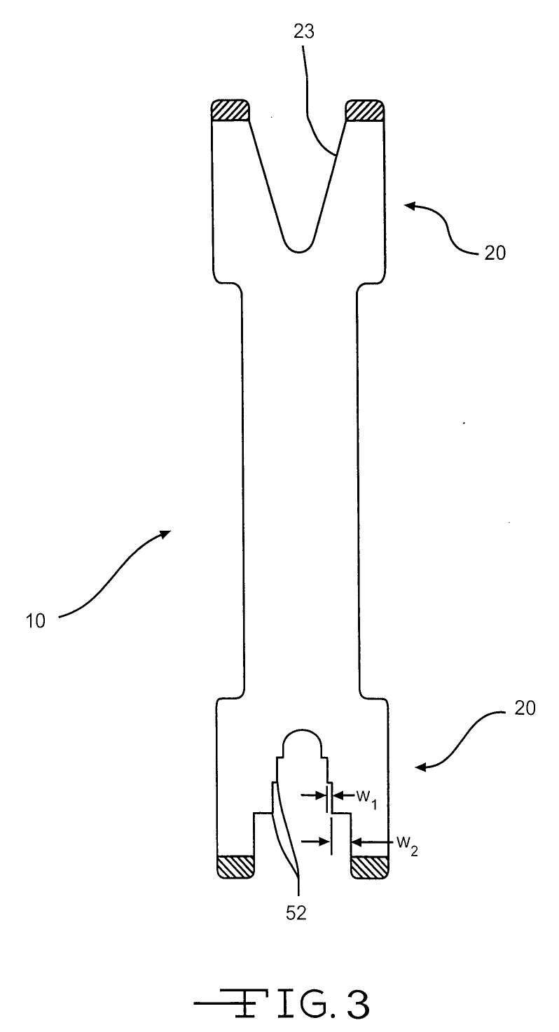

Referring now to FIG. 3, an alternative embodiment of the present disclosure is shown that includes a threadless quick connect tubular coupling disconnection tool 10 with at least two head portions 20. More specifically, this embodiment of the present disclosure includes at least one generally v-shaped head portion 20 with smooth inner walls 23, and at least one generally v-shaped head portion 20 where the inner walls form steps 50.

On the head portion where the opposing inner walls form steps 50, each of the steps 50 have a stepped edge 52. Different widths w₁ and w₂ are defined between the stepped edges 52, and each opposing stepped edge is cooperatively aligned directly across from the other on the opposing inner wall. The stepped edges 52 may have sharp or rounded edges. Optionally, the difference between a first width w₁ of the step and a second width w₂ of the step is between 0.1 and 0.5 inches.

It is also important to note that the construction and arrangement of the elements of the threadless quick connect tubular coupling disconnection tool as shown in the preferred and other exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, etc.) without materially departing from the novel teachings and advantages of the subject matter recited. For example, the length or width of the projections or fingers or head portions may be varied, and/or the nature or number of adjustment positions provided between the elements may be varied. It should be noted that the elements of the threadless quick connect tubular coupling disconnection tool might be constructed from any of a wide variety of materials that provide sufficient strength or durability, and in any of a wide variety of colors, textures and combinations. Accordingly, all such modifications are intended to be included within the scope of the present disclosure. Other substitutions, modifications, changes and omissions may be made in the design, operating conditions and arrangement of the preferred and other exemplary embodiments without departing from the sprit of the present disclosure.

What is claimed is:

1. A threadless hydraulic connector quick coupling disconnection tool comprising:
a head portion with two engagement projection fingers having opposing inner walls, said fingers generally forming a v-shape to operably accept various hose coupling sizes;
a handle; and
a shank connecting said handle portion to said head portion.

2. The disconnection tool of claim 1, wherein said plurality of engagement projection fingers connect at the bottom of said generally v-shaped head portion forming a radius.

3. The disconnection tool of claim 1 wherein said opposing inner walls of said generally v-shaped head portion are smooth.

4. The disconnection tool of claim 1, wherein each of said two engagement projection fingers have two plane face surfaces which lie at an acute angle to one another and terminate in a transverse edge.

5. The disconnection tool of claim 4, wherein said two plane face surfaces lie at the same acute angle to one another to form a peaked edge.

6. The disconnection tool of claim 1, wherein said handle is made of a comfortable to grip material.

7. A threadless quick connect tubular coupling disconnection tool comprising:
a head portion with two engagement projection fingers generally forming a v-shape to accept various hose coupling sizes;
a handle; and
a shank connecting said handle portion to said head portion.

8. The disconnection tool of claim 7, wherein the bottom of said generally v-shaped head portion is curved.

9. The disconnection tool of claim 7, wherein said inner walls of said generally v-shaped head portion are stepped.

10. The disconnection tool of claim 8, wherein there are at least 3 steps in said inner walls of said generally v-shaped head portion.

11. The disconnection tool of claim 7, wherein said two engagement projection fingers are chamfered on at least one side.

12. The disconnection tool of claim 7, wherein said two engagement projection fingers are chamfered on both sides to form a peak.

13. A threadless quick connect tubular coupling disconnection tool comprising:
At least two head portions;
Each of said at least two head portions having two engagement projection fingers generally forming a v-shape to accept various hose coupling sizes; and
A shank connecting said at least two head portions.

14. The disconnection tool of claim 13, wherein said inner walls of one of said at least two head portions are smooth.

15. The disconnection tool of claim 13, wherein said inner walls of one of said at least two head portions are stepped.
